(19) United States
(12) Patent Application Publication
(10) Pub. No.: US 2008/0305847 A1
(43) Pub. Date: Dec. 11, 2008

(54) SLOT MACHINE WITH SYMBOL DETECTION FEATURE

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/932,289

(22) Filed: Oct. 31, 2007

Related U.S. Application Data
(60) Provisional application No. 60/943,245, filed on Jun. 11, 2007.

(51) Int. Cl. A63F 13/00

(52) U.S. Cl. 463/20

(57) ABSTRACT

With a slot machine, a reel band having symbols is wound around a reel and a magnetic tape including magnetic data is provided on the reel band. Then, while the reel is spinning, the symbols displayed on the display windows are detected by reading the magnetic data recorded on the magnetic tape with a magnetic head. And, after the reel has stopped, it is determined whether or not a winning combination is achieved. Therefore, a symbol position can be detected while the reel is spinning. Furthermore, when the reel band should be replaced, replacement work of the reel band can be done easily because a high-precision position adjustment is not necessary between the reel and the reel band.

### CROSS-REFERENCE TO RELATED APPLICATION

This application is based upon and claims the benefit of U.S. Provisional Patent Application Ser. No. 60/943,245, filed on Jun. 11, 2007; the entire contents of which are incorporated herein by reference for all purposes.

### BACKGROUND OF THE INVENTION

1. Field of the Invention

The present invention relates to a slot machine for playing games using game media such as coins, bills and so on.

2. Description of Related Art

U.S. Pat. No. 4,138,114 discloses, a slot machine which executes unit games (slot games) by spinning and stopping a plurality of reels having symbols drawn on respective peripheries.

With slot machines having reels represented by the above-mentioned slot machine, alignment sequence and images of the symbols on a reel can be easily changed by exchanging a reel band having symbols with new alignment sequence and images on its surface.

Here, in a slot machine having reels, it is determined whether or not to award a payout according to the symbol combination as an outcome of the unit game (slot game), in which the spinning reels are stopped and then the stopped symbols are visible through display windows. Therefore, it is necessary to detect the symbol visible through the display window for each reel after the spinning reels has been stopped.

With regard to such detection of symbols, above-mentioned U.S. Pat. No. 4,138,114 discloses a binary code marking which is drawn on each reel together with a symbol to detect the symbol.

Therefore, it is necessary to attach the reel band on the reel with a high precision so that the marking position of the reel will not be in misalignment with the symbol position of the reel band, when changing alignment sequence and images of the symbols on each reel by exchanging the above-mentioned reel band with the slot machine disclosed in U.S. Pat. No. 4,138,114.

If the attaching precision of the reel band on the reel is low, the symbol detected by reading the binary code marking after stopping the reel will not match the symbol which is actually displayed on the display window. Such un-match may lead to awarding a wrong payout which should not be awarded, or missing a payout which should be awarded.

However, attaching a reel band on the reel with a high precision is unrealistic because it requires a highly trained skill.

In addition, U.S. Pat. No. 4,074,258 discloses an apparatus for detecting the position of a movable member. In this apparatus, mutually different identification marks are provided along the movement direction of the movable member at intervals on a belt-shaped scale attached to the movable member. The identification marks are optically read during the movement of the movable member and the position of the movable member is detected based on the read identification marks.

However, the prior art disclosed in the above-mentioned U.S. Pat. No. 4,074,258 detects the position of the belt-shaped scale after moving itself, which has nothing to do with detecting symbols drawn on a reel band.

Furthermore, Japanese Patent Application Laid-Open No. 2003-803, Laid-Open No. 6-170033, and Laid-Open No. 2006-187529 disclose a slot machine comprising a reel having a reel band attached on its periphery, the reel band having symbols on its outer circumferential surface and barcodes corresponding to the symbols on its inner circumferential surface.

In addition, Japanese Patent Application Laid-Open No. 6-246032 and Japanese Patent No. 2772455 (Japanese Patent Application Laid-Open No. 6-277328) disclose a slot machine having code marks, which represent symbols, on an outer or inner circumferential surface of a reel band.

Furthermore, Japanese Patent Application Laid-Open No. 2002-35200 discloses a slot machine having a magnetic tape attached on an inner circumferential surface of a reel band, the magnetic tape including information about symbols on outer circumferential surface of the reel band.

The prior arts disclosed in each of these are all intended to merely check a symbol combination displayed on display windows of a slot machine after reels has stopped, based on a result of reading barcodes (code marks or magnetic tape), which are associated with symbols, on reel bands.

In other words, the prior arts disclosed in each of these do not provide an effective countermeasure to prevent a fraudulent payout when a player fraudulently moves stopped reels to align a winning combination on display windows.

Therefore, a slot machine, which is capable of precisely detecting a symbol(s) displayed on a display window(s) after reel(s) has stopped, has been desired.

It is an object of the present invention to provide a slot machine which executes a game using a reel having symbols on its periphery and can improve the precision of symbol detection when the reel comes to a stop.

### SUMMARY OF THE INVENTION

A first aspect of the present invention provides a slot machine which comprises: a cabinet; at least one reel capable of being spun and stopped; a base frame installed within the cabinet for supporting the reel rotatably; a reel band which is wound around the periphery of the reel and has symbols drawn thereon and at least one identification data recorded thereon for identifying each of the symbols; a display window provided on the front face of the cabinet for displaying a part of the symbols; a data reader provided on the base frame in proximity to the periphery of the reel band for reading the identification data when the reel is spinning; and a controller. The controller is operable to: (a) execute a unit game in which the reel is spun and then stopped; (b) detect, when the reel is spinning, the symbol displayed on the display window based on the identification data read in time series by the data reader; and (c) determine, when the reel has stopped, an outcome of the unit game based on the identification data read by the data reader just before the reel stops.

A second aspect of the present invention provides a slot machine which comprises: a cabinet; at least one reel capable of being spun and stopped; a base frame installed within the cabinet for supporting the reel rotatably; a reel band which is wound around the periphery of the reel and has symbols drawn thereon and at least one identification data recorded thereon (the identification data provides monotonously fluctuant output in accordance with each position of the symbols); a display window provided on the front face of the cabinet for displaying a part of the symbols; a data reader provided on the base frame in proximity to the periphery of the reel band for reading the identification data when the reel is spinning; and a controller. The controller is operable to: (a) execute a unit game in which the reel is spun and then stopped; (b) detect, when the reel is spinning, the symbol displayed on the display window based on the identification data read in time series by the data reader; and (c) determine, when the reel has stopped, an outcome of the unit game based on the identification data read by the data reader just before the reel stops.

A third aspect of the present invention provides a slot machine which comprises: a cabinet; at least one reel capable of being spun and stopped; a base frame installed within the cabinet for supporting the reel rotatably; a reel band which is wound around the periphery of the reel and has symbols drawn thereon and at least one identification data recorded thereon for identifying each of the symbols; a display window provided on the front face of the cabinet for displaying a part of the symbols; a data reader provided on the base frame in proximity to the periphery of the reel band for reading the identification data when the reel is spinning; and a controller. The controller is operable to: (a) execute a unit game in which the reel is spun and then stopped; (b) detect, when the reel is spinning, the symbol displayed on the display window based on the identification data read in time series by the data reader; (c) determine, when the reel has stopped, an outcome of the unit game based on the identification data read by the data reader just before the reel stops; and (d) determine whether or not the symbol displayed on the display window changes after the reel has stopped, based on the detection of the data reader after the reel has stopped.

### BRIEF DESCRIPTION OF THE DRAWINGS

FIG. 1 is a perspective view of a reel unit used in a slot machine in an embodiment of the present invention;

FIG. 2 is a perspective exterior view of the slot machine in the embodiment of the present invention;

FIG. 3 is a block diagram of a controller of the slot machine in the embodiment of the present invention;

FIG. 4 is an exploded perspective view of a reel used in the slot machine in the embodiment of the present invention;

FIG. 5 is an explanatory development view of a reel band used in the slot machine in the embodiment of the present invention;

FIG. 6 is a flow chart showing an operation of the slot machine in the embodiment of the present invention;

FIG. 7 is a flow chart showing an operation of the slot machine in the embodiment of the present invention;

FIG. 8 is an explanatory graph showing magnetic data of a magnetic tape attached on the reel band used in the slot machine in the embodiment of the present invention;

FIG. 9 is an explanatory development view of a reel band used in a modified example of the slot machine in the embodiment of the present invention.

### DETAILED DESCRIPTION OF THE EMBODIMENT

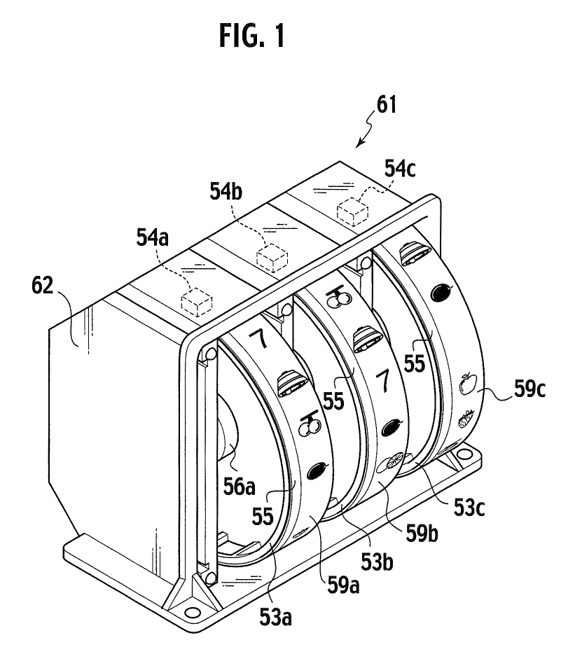

In the following, characteristic portions of a slot machine according to one embodiment of the present invention will be described, referring to the appearance illustration of a reel unit shown in FIG. 1. As shown in FIG. 1, the reel unit 61 of the slot machine according to the present embodiment has three reels 53a to 53c rotatably supported by a base frame 62. Reel bands 59a to 59c are affixed on the periphery of respective reels 53a to 53c. The reel bands 59a to 59c have a magnetic tape 55. Magnetic data (identification data) corresponding to each symbol is recorded on the magnetic tape 55.

In addition, magnetic heads 54a to 54c are provided, respectively, nearby each of the reel bands 59a to 59c of the base frame 62. While the reels 53a to 53c are spinning, the magnetic tape 55 contacts the magnetic heads 54a to 54c, so that magnetic data recorded on the magnetic tape 55 is read by the magnetic heads 54a to 54c. Therefore, the slot machine of the present embodiment can recognize the position of the symbol when the reels spin. Additionally, when the reels 53a to 53c come to a stop, the symbols displayed on the display windows of the slot machine can be recognized based on the symbols recognized just before the stopping and can detect precisely whether or not a winning combination is achieved.

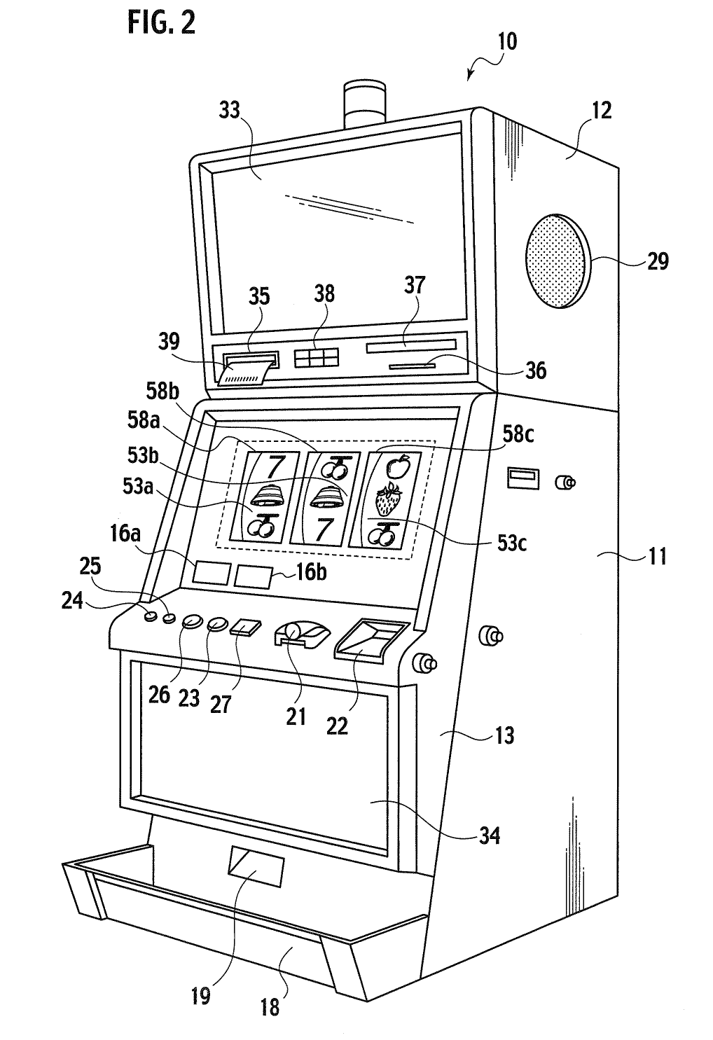

FIG. 2 shows a perspective view of the slot machine 10 of the present embodiment. The slot machine 10 comprises a cabinet 11 and a top box 12 installed on the cabinet 11. A main door 13, which can be opened and closed, is provided on the front of the cabinet 11. Display windows 58a to 58c are provided on the front face of the main door 13. Three left-center-right reels 53a to 53c are installed behind the display windows 58a to 58c and within the cabinet 11.

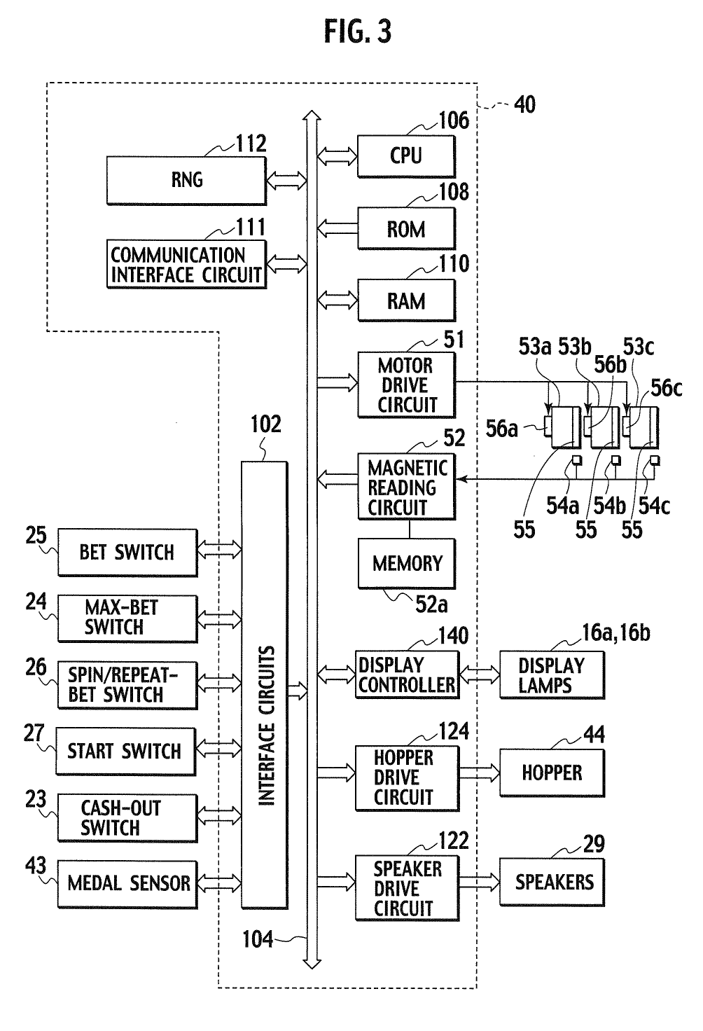

A controller 40 (see FIG. 3) for controlling the slot machine 10 electronically is installed within the cabinet 11. Furthermore, various components such as a hopper 44 (see FIG. 3) for controlling reception, storage and payout of coins are also installed within the cabinet 11.

In the present embodiment, medals are used as game media for playing games but the game media is not limited to medals. For example, coins, tokens, electronic money and electronic value information (credits) equivalent thereto may be used as game media for playing games.

A bet count lamp 16a for displaying the bet amount and a payout count lamp 16b for displaying the payout amount are provided on the middle left-side portion of the main door 13.

A medal insertion slot 21 and a bill validator 22 are installed on the middle of the main door 13. Medals used for playing games are inserted into the medal insertion slot. The bill validator 22 validates whether or not the inserted bill is legitimate and accepts the legitimate bill. In addition, various operation switches are provided near the medal insertion slot 21 and the bill validator 22.

A cash-out switch 23, a max-bet switch 24, a bet switch 25, a spin/repeat-bet switch 26 and a start switch 27 are provided as the operation switches.

The bet switch 25 is a switch for determining the number of bet credits on a slot game done with the reels 53a to 53c. One credit equivalent to one medal is bet per one press of the bet switch 25.

The spin/repeat-bet switch 26 is a switch for betting credits same as the credits that were bet on the previous game by the bet switch 25 and starting spins of the reels 53a to 53c. With the spin/repeat-bet switch 26, a bet same as the bet of the previous game can be placed without any change and a next game can be played with the same bet again.

The start switch 27 is a switch for starting a slot game after the bet operation. The slot game with spinning the reels 53a to 53c is started when the start switch 27 has been pressed after the medal insertion into the medal insertion slot 21 or the credits bet by the bet switch 25.

The cash-out switch 23 is a switch for cashing out the prized medals. The medals are cashed out from a medal cash-out opening 19 opened on the lower portion of the main door 13. The cashed-out medals are stored on a medal tray 18.

The max-bet switch 24 is a switch for betting maximum credits (for example, credits equivalent to 30 medals) that can be bet on a single game with a single operation.

A lower display 34 is provided on the lower front of the main door 13. Images relating to the game of the slot machine 10 are displayed on the lower display 34. The images may be mascot character images of the slot machine 10. The medal cash-out opening 19 is provided beneath the lower display 34.

An upper display 33 is provided on the front of the top box 12. The upper display panel 33 has a display panel. The number of payout medals corresponding to symbol combinations and so on are displayed on the upper display 33.

The top box 12 is provided with speakers 29. A ticket printer 35, a card reader 36, a data display 37 and a keypad 38 are provided below the upper display panel 33. The ticket printer 35 prints out the bar code ticket 39. Data of the credits, the date, the identification number of the slot machine 10, etc. has been encoded into bar code and printed on the bar code ticket 39.

A player can play games with another slot machine using the bar code ticket 39 and exchange the bar code ticket 39 with bills etc. at a specific location in the gaming facility (such as a cashier booth in a casino).

A smart card can be inserted into the card reader 36. The card reader 36 reads data from the smart card and writes data into the same. The smart card is carried by a player. Identification data of the player, the game history data of the player and so on are stored in the smart card.

FIG. 3 is a block diagram showing a controller 40 provided with the slot machine 10 of the present embodiment and various electrical components connected with the controller 40. The controller 40 of the slot machine 10 shown in FIG. 3 is a micro-computer and includes interface circuits 102, an I/O bus 104, a CPU 106, a ROM 108, A RAM 110, a communication interface circuit 111, a random number generator (RNG) 112, a speaker drive circuit 122, a hopper drive circuit 124, a display controller 140, a motor drive circuit 51 and a magnetic reading circuit 52.

The interface circuits 102 are connected with the I/O bus 104. The I/O bus 104 transfers data signals to the CPU106 and the address signals.

The start switch 27 is connected to the interface circuits 102. Power-on signal output from the start switch 27 is converted into a prescribed signal and transferred to the CPU 106 via the I/O bus 104.

Furthermore, the interface circuits 102 are connected with the bet switch 25, the max-bet switch 24, the spin/repeat-bet switch 26 and the cash-out switch 23. The switching signals output from these switches 25, 24, 26, 23 are supplied to the interface circuits 102 and converted into a prescribed signals at the interface circuits 102 to be transferred to the CPU 106 via the I/O bus 104.

In addition, the interface circuits 102 are connected with a medal sensor 43. The medal sensor 43 is a sensor for detecting inserted medals into the medal insertion slot 21 and installed within the medal insertion slot 21. Signals output from the medal sensor 43 are supplied to the interface circuits 102 and converted into a prescribed signals at the interface circuits 102 to be transferred to the CPU 106 via the I/O bus 104.

The ROM 108 storing system programs and the RAM 110 storing various kinds of data are connected to the I/O bus 104. Further, the RNG 112, the communication interface circuit 111, the display controller 140, the hopper drive circuit 124, the speaker drive circuit 122, the motor drive circuit 51 and the magnetic reading circuit 52 are connected to the I/O bus 104.

The CPU 106 reads game execution programs and executes a game with triggering by receiving the game starting operation via the start switch 27. The game execution programs are programs for executing the processing of spinning and then stopping the reels 53a to 53c by the motor drive circuit 51.

In other words, the game execution programs are programmed to execute a slot game. In the slot game executed by the game execution programs, the reels 53a to 53c are spun and then a payout will be provided in case where symbols constituting a winning combination have been arranged along a prescribed payline based on the stopped symbols on the reels 53a to 53c.

The communication interface circuit 111 is connected to a hall sever or the like and transfers a game history of the slot machine 10 and so on to the hall server. In addition, as described below, the communication interface circuit 111 transfers a warning signal to inform an administrator of fraudulent spinning of the reels when the reels 53a to 53c are spun by a fraudulent conduct after stopping the spinning of the reels 53a to 53c with an end of a slot game. The communication interface circuit 111 also receives various kinds of data transferred from the hall server.

The RNG 112 generates random numbers for determining the stop positions of the reels 53a to 53c.

The speaker drive circuit 122 outputs sound data to the speakers 29. More specifically, the CPU 106 reads out the sound data stored in the ROM 108 and transfers the sound data to the speaker drive circuit 122 via the I/O bus 104. As a result, a desired sound effect is output from the speakers 29.

The hopper drive circuit 124 outputs a payout signal to the hopper 44 when a cash-out will be provided. More specifically, the CPU 106 transfers a driving signal to the hopper drive circuit 124 via the I/O bus 104 when a cash-out signal is generated by the cash-out switch 23. As a result, the hopper 44 cashes out medals corresponding to the remaining credits stored in a specific memory area in the RAM 111.

The display controller 140 executes processing for displaying the number of bet on the bet count lamp 16a and processing for displaying the number of payout on the payout count lamp 16b.

The motor drive circuit 51 is connected to pulse motors 56a to 56c which spin three reels 53a to 53c, respectively. The motor drive circuit 51 spins or stops the respective reels 53a to 53c by outputting a driving signal or a stopping signal to each of the pulse motors 56a to 56c. In other words, a driving signal is output to each of the pulse motors 56a to 56c when the start switch 27 has been pressed, and then each of the reels 53a to 53c is spun. Each of the pulse motors 56a to 56c is stopped after a prescribed period (e.g., five seconds) has passed, and then the spin of respective reels 53a to 53c is stopped

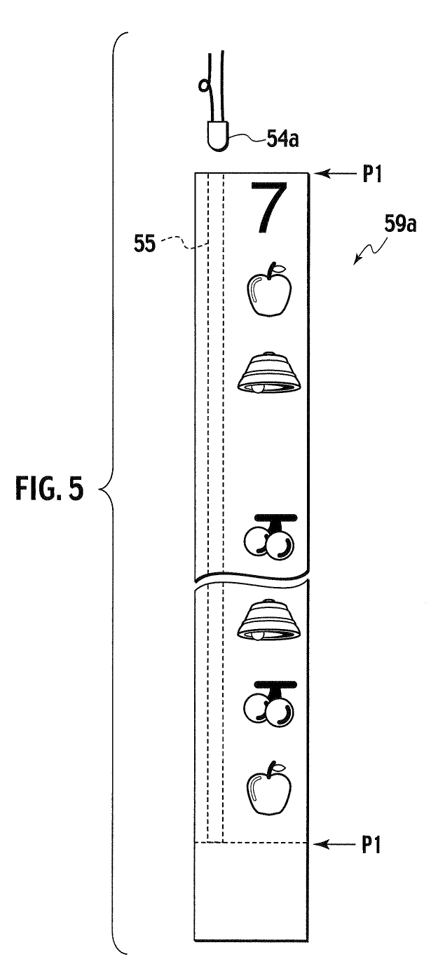

Reel bands 59a to 59c (see FIG. 5), on which a plurality of symbols are drawn, are wound around the respective reels 53a to 53c. In addition, a magnetic tape 55 is attached to the respective reel bands 59a to 59c along the circumferential direction. Furthermore, magnetic heads (data reader) 54a to 54c for reading the magnetic data (identification data) recorded on each magnetic tape 55 are attached so as to contact each magnetic tape 55. Each of the magnetic heads 54a to 54c is connected to a magnetic reading circuit 52.

A memory 52a is connected to the magnetic reading circuit 52. Reference data of the magnetic data corresponding to each symbol is recorded in the memory 52a. Then, the magnetic reading circuit 52 determines symbol positions based on the magnetic data read by each of the magnetic heads 54a to 54c and the reference data stored in the memory 52a.

In other words, the magnetic data recorded on the magnetic tape 55 of respective reels 53a to 53c is read by each of the magnetic heads 54a to 54c when the reels 53a to 53c spin. The magnetic reading circuit 52 compares the read magnetic data with the reference data stored in the memory 52a and determines the symbol positions.

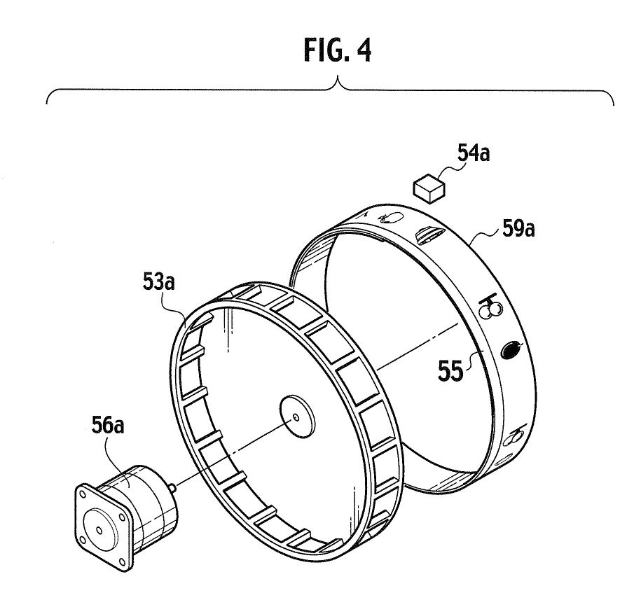

Next, the reel bands 59a to 59c wound around the reels 53a to 53c will be described. Note that, although the reel 53a on the left column is described as an example in the following, reels 53b and 53c on the middle and right columns are similarly arranged. FIG. 4 is an exploded perspective view illustrating the reel 53a and the reel band 59a wound around the reel 53a, the pulse motor 56a, and the magnetic head 54a. In addition, FIG. 5 is a detailed explanatory drawing of the reel band 59a. FIG. 1 mentioned above is a perspective view illustrating a reel unit 61 having three reels 53a to 53c attached thereon.

As shown in FIG. 5, the reel band 59a is a rectangular tape and has a plurality of symbols drawn thereon such as “7”, “APPLE”, “BELL”, or the like. In addition, the magnetic tape 55 is provided on the side edge of the reel band 59a along its longitudinal direction. The magnetic tape 55 stores magnetic data (identification data) corresponding to the symbols of the reel band 59a drawn thereon. Details will be described below.

Then, as shown in FIG. 4, the reel band 59a is wound around the periphery of the reel 53a with both ends joined together, and is fixed to the reel 53a. Specifically, as shown in FIG. 5, the reel band 59a is made into a ring by coupling the positions of a pair of P1 with each other to be fixed to the reel 53a. On this occasion, the reel band 59a is partially fixed in a condition being wound around the reel 53a using adhesive or the like, so that it will be able to be replaced easily. If the reel band 59a is not intended to be replaced, the reel band 59a can be fixed to the reel 53a entirely using adhesive or the like.

Additionally, as shown in FIG. 4, the rotation shaft of the pulse motor 56a is coupled to the center of the reel 53a. The spinning or stopping of the reel 53a is controlled by the pulse motor 56a.

Additionally, as shown in FIG. 1, the pulse motors 56a to 56c and the reels 53a to 53c are fixed to the base frame 62. The magnetic heads 54a to 54c are provided on the upper part of the base frame 62 to contact the magnetic tapes 55 of the reel bands 59a to 59c respectively. The magnetic heads 54a to 54c read the magnetic data recorded on the magnetic tapes 55. The magnetic data read by the magnetic heads 54a to 54c is output to the magnetic reading circuit 52 shown in FIG. 3.

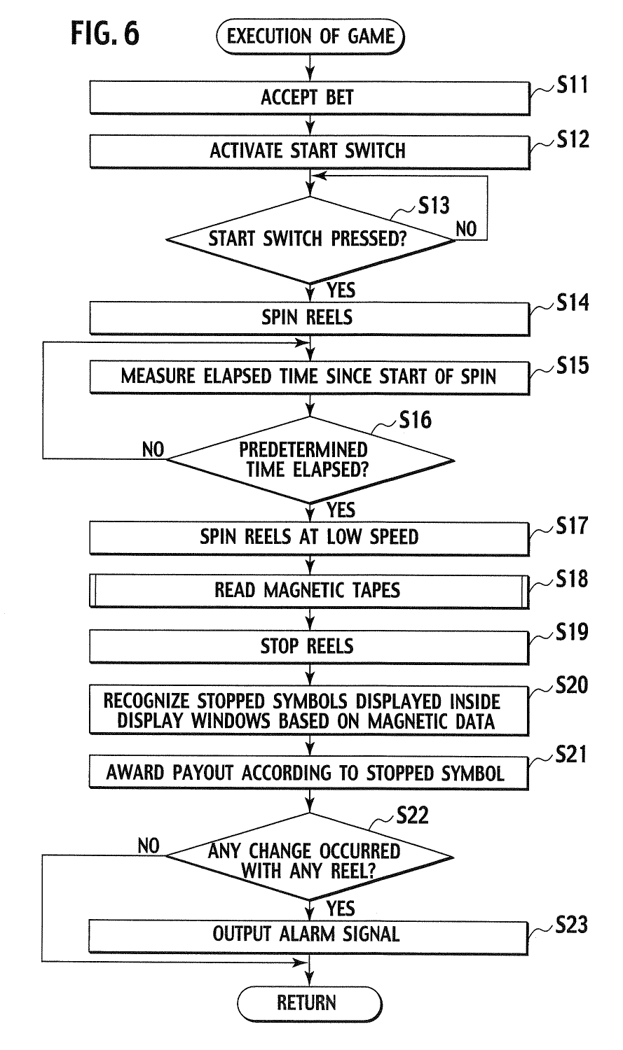

Next, operation of the slot machine according to the present embodiment will be described. FIG. 6 is a flow chart illustrating the operation of the slot machine according to the present embodiment.

First, the CPU 106 accepts a bet placed by a player (step S11). Here, when the player inserts one or more medals to the medal insertion slot 21, or operates the bet switch 25, the max-bet switch 24 or the spin/repeat-bet switch 26, the number of medals or credits that have been bet is counted as a bet number.

The CPU 106 activates the start switch 27 (step S12). As a result, the player can spin the reels 53a to 53c by pressing the start switch 27.

The CPU 106 determines whether or not the start switch 27 has been pressed (step S13). If it is determined that the start switch 27 has been pressed, the process proceeds to step S14. If it is determined that the start switch 27 has not been pressed, the process of step S13 is repeated.

The CPU 106 outputs a drive command signal of the reels 53a to 53c to the motor drive circuit 51 (step S14). When the drive command signal is supplied, the motor drive circuit 51 supplies electric power to each of the pulse motors 56a to 56c to spin reels 53a to 53c.

The CPU 106 measures the elapsed time since the reels 53a to 53c has started to spin by a timer which has been implemented in the RAM 110 (step S15).

The CPU 106 determines whether or not the elapsed time measured by the timer has reached a prescribed time period (e.g. five seconds) (step S16). If it is determined that the prescribed time has passed, the process proceeds to step S17. If it is determined that the prescribed time has not passed, the process returns to step S15.

The CPU 106 outputs a low-speed spinning command signal to the motor drive circuit 51. When the low-speed spinning command signal is supplied, the motor drive circuit 51 spins each of the pulse motors 56a to 56c at a low speed (step S17) As a result, the reels 53a to 53c spin at a low speed.

The CPU 106 outputs a read command signal for reading the magnetic tapes 55 to the magnetic reading circuit 52 (step S18). When the read command signal is supplied, the magnetic reading circuit 52 executes a reading process of the magnetic data recorded on the magnetic tapes 55 of the reel bands 59a to 59c by the magnetic heads 54a to 54c.

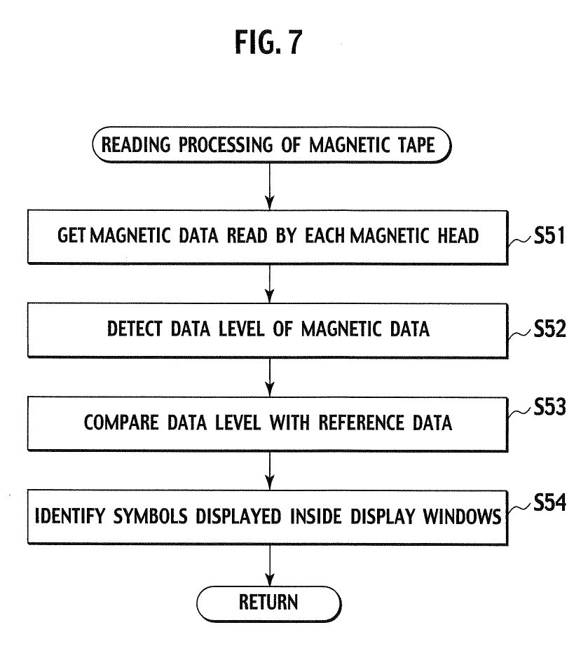

The reading process of the magnetic tape will be described referring to the flow chart shown in FIG. 7 in the following.

As shown in FIG. 7, the magnetic reading circuit 52 gets magnetic data via each of the magnetic heads 54a to 54c (step S51). Here, the magnetic data is stored in the magnetic tape 55 of respective reel bands 59a to 59c. Output level of this magnetic data varies according to the symbols drawn on the reel bands 59a to 59c. Since the reels 53a to 53c are spinning at a low speed, the magnetic data by the magnetic heads 54a to 54c can be read surely.

Subsequently, the magnetic reading circuit 52 detects data level of the magnetic data (step S52).

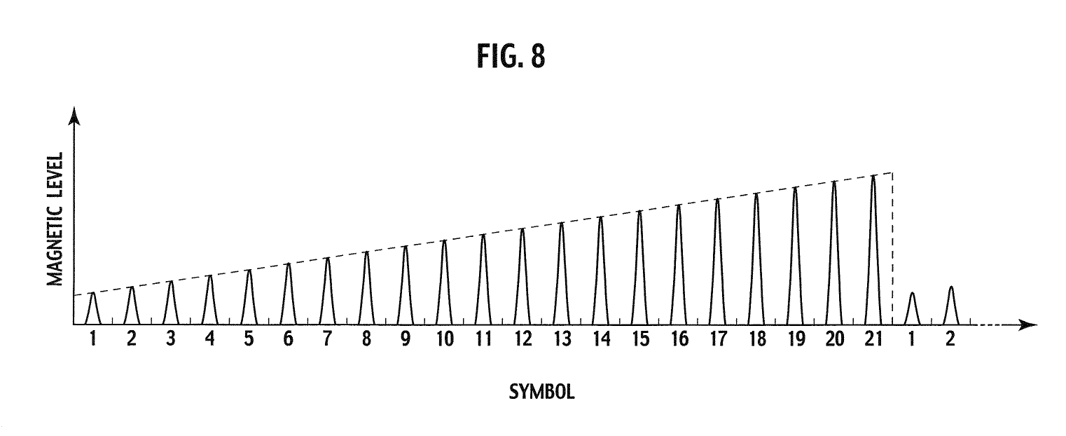

The magnetic data recorded on one of the magnetic tape 55 will be described in detail referring to FIG. 8 in the following. The numbers indicated along the horizontal axis of FIG. 8 represent the symbols drawn on respective reel bands 59a to 59c. In other words, 21 symbols (including blank) “1” to “21” are drawn on one of the reel bands 59a to 59c in this example. Then, the output level of the magnetic data recorded for each symbol varies according to the symbols drawn on the magnetic tape. For example, when a symbol is shown on a middle of the display window 58a, a magnetic data corresponding to this symbol is recorded at a contact position with the magnetic head 54a on the magnetic tape 55 of the reel band 59a. The magnetic data is provided such that the output level gradually increases from symbol “1” to symbol “21”. Furthermore, reference data is stored in the memory 52a. This reference data defines output level corresponding to each of the symbols.

Then, as shown in FIG. 7, the magnetic reading circuit 52 compares the magnetic data read by the magnetic heads 54a to 54c with the reference data stored in the memory 52a (step S53). Then, the magnetic reading circuit 52 identifies the symbol displayed within the display windows 58a to 58c based on this comparison (step S54).

In other words, since the amplitude level of the magnetic data is made different for each of the positions “1” to “21” of respective symbols, the symbols at the position contacted by the magnetic heads 54a to 54c can be identified based on the amplitude level of the magnetic data read by the magnetic heads 54a to 54c. Furthermore, the symbols displayed on the display windows 58a to 58c can be identified based on the relationship between the contact positions of the magnetic heads 54a to 54c and the positions of the display windows 58a to 58c.

Subsequently, as shown in FIG. 6, the CPU 106 stops the spin of the reels 53a to 53c (step S19). The CPU 106 recognizes the symbols which have stopped on the display windows 58a to 58c based on the magnetic data read in the process of step S54 of FIG. 7 (step S20).

The CPU 106 awards a payout according to the symbols displayed within the display windows 58a to 58c (step S21). For example, five activated lines (horizontally middle, horizontally upper, horizontally lower, diagonally right-upward and diagonally right-downward lines) are defined over the display windows 58a to 58c. When symbols composing a winning combination have come to a stop along at least one of these activated lines, a payout according to the winning combination is awarded.

For example, when a combination “bell-bell-bell” has aligned on an activated line, ten medals or ten credits (equivalent to ten medals) are awarded as a payout.

The CPU 106 determines whether or not the stopped state of the reels 53a to 53c has changed, based on the detection process of the magnetic heads 54a to 54c by the magnetic reading circuit 52 (step S22). In other words, the CPU 106 continues reading of the magnetic tape 55 by the magnetic heads 54a to 54c after the reels 53a to 53c have stopped. The CPU 106 determines whether or not any of the reels 53a to 53c was spun after the reels 53a to 53c have stopped based on the magnetic data read by the magnetic heads 54a to 54c. If it is determined that any of the reels 53a to 53c was spun based on the determination in step S22, the process proceeds to step S23. If it is determined that none of the reels 53a to 53c has spun, the process is finished.

If it is determined that any of the reels 53a to 53c has spun, the CPU 106 outputs an alarm signal (step S23). The alarm signal is transmitted to a host computer (not shown) via a communicating interface circuit 111.

In other words, if any of the reels 53a to 53c spun for some reason and any of the symbols displayed on the display windows 58a to 58c has changed after the determination of the stopped symbols displayed on the display windows 58a to 58c, it is detected by the magnetic reading circuit 52 that any of the symbols has changed. Then, the alarm signal is output to notify a staff of the slot machine 10 that any of the symbols has changed. The staff of the slot machine 10 can find out malfunction or fraudulent operation of the slot machine 10 through the notification by the alarm signal.

In this manner, the slot machine 10 according to the present embodiment detects the symbol positions of the reels 53a to 53c by attaching magnetic tapes 55 with the magnetic data (identification data) recorded thereon to each of the reel bands 59a to 59c and contacting the magnetic heads 54a to 54c to the magnetic tapes 55. Therefore, the symbol positions of the reels 53a to 53c can be specified while the reels 53a to 53c are spinning.

Additionally, since the symbol positions are detected based on the magnetic data recorded on the magnetic tapes 55 of the reel bands 59a to 59c, a highly precise positional adjustment is not required between the reels 53a to 53c and the reel bands 59a to 59c when the reel bands 59a to 59c are replaced with new ones.

In addition, the slot machine 10 according to the present embodiment can detect the spin of the reels 53a to 53c caused by vibrations or other factors which affect the slot machine 10 after the reels 53a to 53c have come to a stop.

Furthermore, the slot machine 10 according to the present embodiment specifies the symbol positions of the reel bands 59a to 59c by winding the reel bands 59a to 59c around respective reels 53a to 53c and reading the magnetic data of the magnetic tapes 55 of the reel bands 59a to 59c. Hence, the symbol positions can be reliably specified even if a highly precise alignment between the reels 53a to 53c and the reel bands 59a to 59c has not be done.

Next, a variation of the above-mentioned embodiment will be described. In the above embodiment, the symbol positions of the reel bands 59a to 59c are detected by providing the magnetic tapes 55 on the reel bands 59a to 59c. This variation differs from the embodiment in that barcodes 65 are used instead of the magnetic tapes 55.

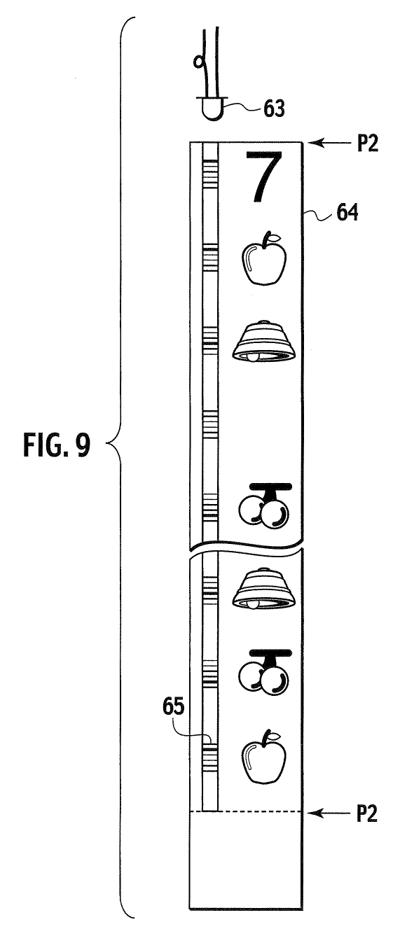

FIG. 9 is an explanatory development view of a reel band 64 according to this variation. As shown in FIG. 9, the reel band 64 has barcodes 65 drawn thereon along its longitudinal direction. Data corresponding to the symbols on the reel band 64 (identification data) is recorded in the barcodes 65.

Additionally, in place of the magnetic heads 54a to 54c shown in FIGS. 1, 4 and 5, a barcode reader (data reader) 63 is used in this variation. The barcode reader 63 is not contacted with the barcodes 65 to read the data.

Therefore, the barcodes 65 of the reel band 64 is read by the barcode reader 63 while the reels 53a to 53c are spinning. The symbols displayed on the display windows 58a to 58c can be specified based on the barcode data detected by the barcode reader 63 when the reels 53a to 53c are spinning at a low speed.

Although embodiments of the present invention have been described as above, they are only presented as specific examples, without particularly limiting the present invention. Specific arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

What is claimed is:

1. A slot machine with symbol detection feature, comprising:
a cabinet;
at least one reel capable of being spun and stopped;
a base frame installed within the cabinet for supporting the reel rotatably;
a reel band which is wound around the periphery of the reel and has symbols drawn thereon and at least one identification data recorded thereon for identifying each of the symbols;
a display window provided on the front face of the cabinet for displaying a part of the symbols;
a data reader provided on the base frame in proximity to the periphery of the reel band for reading the identification data when the reel is spinning; and
a controller operable to:
(a) execute a unit game in which the reel is spun and then stopped;
(b) detect, when the reel is spinning, the symbol displayed on the display window based on the identification data read in time series by the data reader; and
(c) determine, when the reel has stopped, an outcome of the unit game based on the identification data read by the data reader just before the reel stops.

2. The slot machine according to claim 1, wherein the identification data is magnetic data recorded on a magnetic tape on the reel band, and
the data reader reads the magnetic data in contact with the magnetic tape.

3. The slot machine according to claim 1, wherein
the identification data is barcode data recorded on the reel band, and
the data reader reads the barcode data in non-contact with the reel band.

4. A slot machine with symbol detection feature, comprising:
a cabinet;
at least one reel capable of being spun and stopped;
a base frame installed within the cabinet for supporting the reel rotatably;
a reel band which is wound around the periphery of the reel and has symbols drawn thereon and at least one identification data recorded thereon, the identification data providing monotonously fluctuant output in accordance with each position of the symbols;
a display window provided on the front face of the cabinet for displaying a part of the symbols;
a data reader provided on the base frame in proximity to the periphery of the reel band for reading the identification data when the reel is spinning; and
a controller operable to:
(a) execute a unit game in which the reel is spun and then stopped;
(b) detect, when the reel is spinning, the symbol displayed on the display window based on the identification data read in time series by the data reader; and
(c) determine, when the reel has stopped, an outcome of the unit game based on the identification data read by the data reader just before the reel stops.

5. The slot machine according to claim 4, wherein
the identification data is magnetic data recorded on a magnetic tape on the reel band, and
the data reader reads the magnetic data in contact with the magnetic tape.

6. The slot machine according to claim 4, wherein
the identification data is barcode data recorded on the reel band, and
the data reader reads the barcode data in non-contact with the reel band.

7. A slot machine with symbol detection feature, comprising:
a cabinet;
at least one reel capable of being spun and stopped;
a base frame installed within the cabinet for supporting the reel rotatably;
a reel band which is wound around the periphery of the reel and has symbols drawn thereon and at least one identification data recorded thereon for identifying each of the symbols;
a display window provided on the front face of the cabinet for displaying a part of the symbols;
a data reader provided on the base frame in proximity to the periphery of the reel band for reading the identification data when the reel is spinning; and
a controller operable to:
(a) execute a unit game in which the reel is spun and then stopped;
(b) detect, when the reel is spinning, the symbol displayed on the display window based on the identification data read in time series by the data reader;
(c) determine, when the reel has stopped, an outcome of the unit game based on the identification data read by the data reader just before the reel stops; and
(d) determine whether or not the symbol displayed on the display window changes after the reel has stopped, based on the detection of the data reader after the reel has stopped.

8. The slot machine according to claim 7, wherein
the identification data is magnetic data recorded on a magnetic tape on the reel band, and
the data reader reads the magnetic data in contact with the magnetic tape.

9. The slot machine according to claim 7, wherein
the identification data is barcode data recorded on the reel band, and
the data reader reads the barcode data in non-contact with the reel band.

10. The slot machine according to claim 7, wherein
the controller outputs an alarm signal when the symbol displayed on the display window changes after the reel has stopped in (d).
